(19) United States
(12) Patent Application Publication
(10) Pub. No.: US 2025/0284698 A1
(43) Pub. Date: Sep. 11, 2025

(54) SYSTEM AND METHOD FOR GENERATION OF AN AGENT

(71) Applicant: K2View Ltd., Yokneam Illit (IL)

(72) Inventor: Yuval PERLOV, Kochav Yair (IL)

(73) Assignee: K2View Ltd., Yokneam Illit (IL)

(21) Appl. No.: 19/052,550

(22) Filed: Feb. 13, 2025

Related U.S. Application Data
(60) Provisional application No. 63/562,856, filed on Mar. 8, 2024.

(51) Int. Cl. G06F 16/2457; G06F 16/2452

(52) U.S. Cl. CPC G06F 16/24575; G06F 16/24522

(57) ABSTRACT

Systems and methods of generating an agent, including: generating a plurality of contextual relationships that exist between data points in a dataset by applying a large language model (LLM) to the dataset, determining at least one insight based on the dataset with the generated plurality of contextual relationships, determining at least one query for each determined at least one insight, receiving a question for the dataset, if the received question is associated with the determined at least one insight, applying, by the processor, the LLM on the determined at least one query for the associated determined at least one insight, generating the agent by the LLM based on the determined at least one query, and updating the LLM based on performance of the generated agent.

### CROSS-REFERENCE TO RELATED APPLICATIONS

This application claims the benefit of U.S. Provisional Patent Application No. 63/562,856, filed Mar. 8, 2024, which is hereby incorporated by reference.

### FIELD OF THE INVENTION

The present invention relates to generative AI (artificial intelligence). More particularly, the present invention relates to systems and methods for generation of agents using generative AI.

### BACKGROUND OF THE INVENTION

Generative AI can involve AI focused on generating and/or creating new content, like text (e.g., poems, code, scripts, and/or musical pieces), images (e.g., portraits, landscapes, and/or abstract art), audio (e.g., music, sound effects, and/or voiceovers), and/or videos (e.g., short clips, and/or animations).

Generative AI can work by learning the patterns and/or relationships within existing data, and using that knowledge to generate entirely new but similar outputs in response to prompt(s) from a user.

A large language model (LLM) is a deep learning algorithm that can perform a variety of natural language processing (NLP) tasks. Large language models can use transformer models and can be trained using large datasets. This can enable them to recognize, translate, predict, and/or generate text, and can enable answering questions in a conversational manner. For example, the LLM can answer questions in response to questions or prompt(s) from a user.

A data fabric can be used as a data layer for LLM conversational interface. A data fabric can involve an information architecture that functions as a fabric (or fabric of data). The data fabric can connect multiple places, sources, and/or types of data as it grows and changes in real time. A data fabric can be considered as a data operational layer that transforms and/or processes it using user inputs or machine learning to discover patterns and/or insights.

The data fabric system can start with a modeled business entity that has a consistent relational schema (e.g., a machine-processable specifications) describing the entity. Each instance of the entity (e.g., or a specific customer) can be kept in a separate database (e.g., a minimalistic file-based JavaScript Object Notation (JSON) object database, such as MicroDB) that can be completely separated from other entities. The data fabric system can have the capability to keep data in the database always fresh (e.g., with minimum time elapsed since generation of the data) from various data sources in the enterprise at substantially high speeds. The sources can be databases, application programming interfaces (APIs), scripts and files, with a combination of push/pull/just in time techniques.

The data fabric architecture can be a suitable data layer for LLM conversational interfaces since the data is always fresh, the data can be focused on the specific context needed by the LLM focusing the LLM and improving the odds of a relevant answer and fast response time.

Security and privacy can also be built into the data fabric architecture. Since the LLM only has access to relevant data, it cannot be manipulated into retrieving data that the end user is not privileged to, and any data used by the LLM can be deleted on demand or once the session is ended. However, generative AI based solutions may also suffer from hallucination (with wrong responses), risk of data leaks, and that the data used by the state-of-the-art solution is not updated in real-time.

### SUMMARY OF THE INVENTION

There is thus provided, in accordance with some embodiments of the invention, a method of generating an agent, including: generating, by a processor, a plurality of contextual relationships that exist between data points in a dataset by applying a large language model (LLM) to the dataset, determining, by the processor, at least one insight based on the dataset with the generated plurality of contextual relationships, by applying the LLM on the dataset with the generated plurality of contextual relationships, determining, by the processor, at least one query for each determined at least one insight, by applying the LLM on the dataset with the generated plurality of contextual relationships and determined at least one insight, receiving, by the processor, a question for the dataset, if the received question is associated with the determined at least one insight, applying, by the processor, the LLM on the determined at least one query for the associated determined at least one insight, generating, by the processor, the agent by the LLM based on the determined at least one query, and updating the LLM based on performance of the generated agent.

In some embodiments, if the received question is not associated with the determined at least one insight, a new query is generated by the LLM for the associated determined at least one insight. In some embodiments, the generated agent is applied on at least one received user query. In some embodiments, the dataset includes a semantic layer of information of the dataset. In some embodiments, the information is received from a dedicated database. In some embodiments, the at least one insight is determined by a corresponding at least one query to the dedicated database.

There is thus provided, in accordance with some embodiments of the invention, a system for generating an agent, including: a server, including a dataset with a plurality of data points, and a processor, in communication with the server, where the processor is configured to: generate a plurality of contextual relationships that exist between data points in the dataset by applying a large language model (LLM) to the dataset, determine at least one insight based on the dataset with the generated plurality of contextual relationships, by applying the LLM on the dataset with the generated plurality of contextual relationships, determine at least one query for each determined at least one insight, by applying the LLM on the dataset with the generated plurality of contextual relationships and determined at least one insight, receive a question for the dataset, if the received question is associated with the determined at least one insight, apply the LLM on the determined at least one query for the associated determined at least one insight, generate the agent by the LLM based on the determined at least one query, and update the LLM based on performance of the generated agent.

In some embodiments, the processor is configured to generate a new query by the LLM for the associated determined at least one insight, if the received question is not associated with the determined at least one insight. In some embodiments, the processor is configured to apply the generated agent on at least one received user query. In some embodiments, the dataset includes a semantic layer of information of the dataset. In some embodiments, the information is received from a dedicated database. In some embodiments, the at least one insight is determined by a corresponding at least one query to the dedicated database.

There is thus provided, in accordance with some embodiments of the invention, a computer-readable medium including instructions which, when executed by a processor, cause the processor to: generate a plurality of contextual relationships that exist between data points in a dataset by applying a large language model (LLM) to the dataset, determine at least one insight based on the dataset with the generated plurality of contextual relationships, by applying the LLM on the dataset with the generated plurality of contextual relationships, determine at least one query for each determined at least one insight, by applying the LLM on the dataset with the generated plurality of contextual relationships and determined at least one insight, receive a question for the dataset, if the received question is associated with the determined at least one insight, apply the LLM on the determined at least one query for the associated determined at least one insight, generate the agent by the LLM based on the determined at least one query, and update the LLM based on performance of the generated agent.

In some embodiments, the processor is further configured to generate a new query by the LLM for the associated determined at least one insight, if the received question is not associated with the determined at least one insight. In some embodiments, the processor is further configured to apply the generated agent on at least one received user query. In some embodiments, the dataset includes a semantic layer of information of the dataset. In some embodiments, the information is received from a dedicated database. In some embodiments, the at least one insight is determined by a corresponding at least one query to the dedicated database.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of a computing device, according to some embodiments of the invention;

FIG. 2, which shows a block diagram for an agent generation system, according to some embodiments of the invention; and

FIGS. 3A-3B show a flowchart for answering a user's query using LLM, according to some embodiments of the invention; and

FIGS. 4A-4B, which show a flowchart for a method of generating an agent, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details.

In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence. Additionally, some of the described method embodiments or elements thereof may occur or be performed simultaneously, at the same point in time, or concurrently.

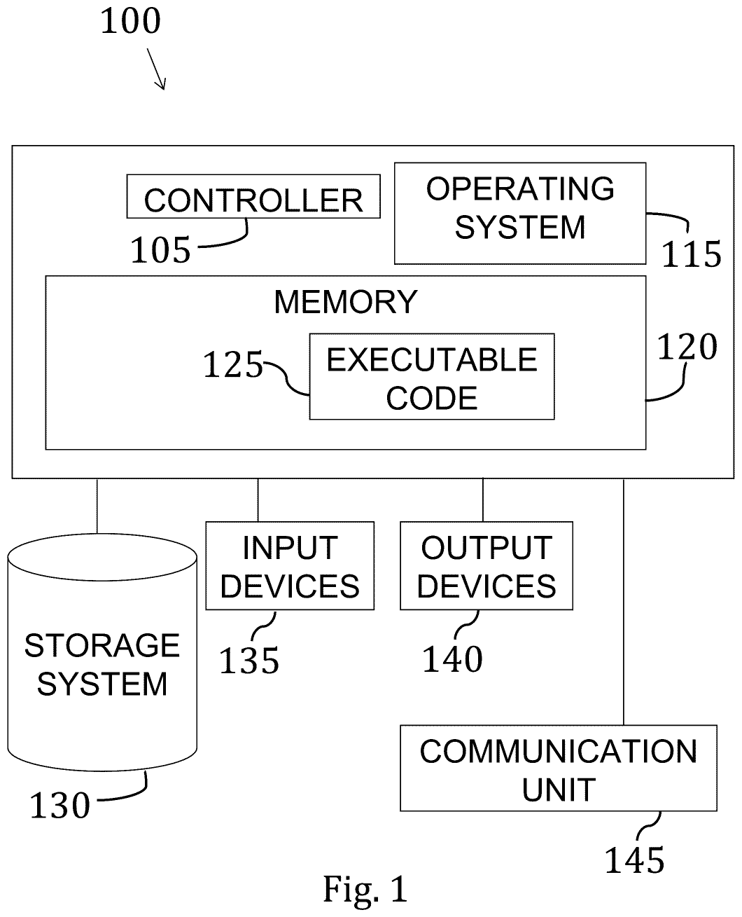

Reference is made to FIG. 1, which is a block diagram of an example computing device, according to some embodiments of the invention. Computing device 100 may include a controller or processor 105 (e.g., a central processing unit processor (CPU), a chip or any suitable computing or computational device), an operating system 115, memory 120, executable code 125, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a communication network, such as, for example, the Internet.

Controller 105 may be configured to execute program code to perform operations described herein. The system described herein may include one or more computing device(s) 100. For example, communication system 200 may be, or may include computing device 100 or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of similar and/or different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein.

Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 are omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100.

Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105.

Such a non-transitory computer readable medium may be for example a memory, a disk drive, or a USB flash memory, encoding, including or storing instructions, e.g., computer-executable instructions, which when executed by a processor or controller, carry out methods disclosed herein.

The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

In some embodiments, a system may include or may be, for example, a personal computer, a desktop computer, a laptop computer, a workstation, a server computer, a network device, or any other suitable computing device.

A system according to embodiments of the invention may include components such as, but not limited to, a plurality of central processing units (CPUs), a plurality of graphics processing units (GPUs), or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components.

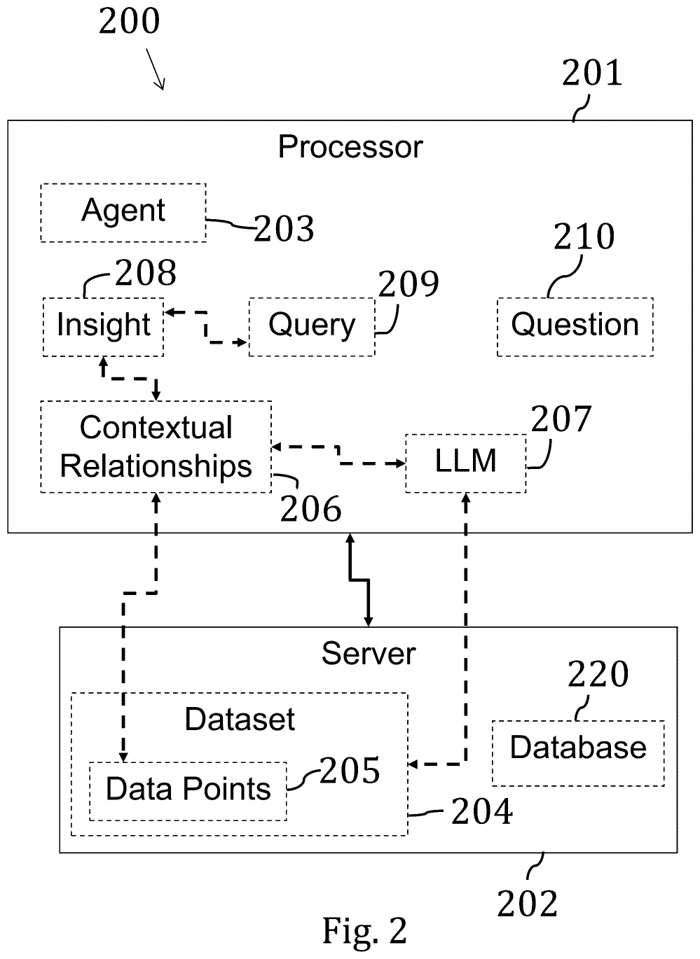

Reference is now made to FIG. 2, which shows a block diagram for an agent generation system 200, according to some embodiments of the invention. In FIG. 2, some hardware elements may be indicated by a solid line while some software elements may be indicated by a dashed line.

According to some embodiments, the agent generation system 200 includes a processor 201 in communication with a server 202 (e.g., communicating over the Internet). The processor 201 may be configured to generate an agent 203 based on information from the server 202, as further described hereinafter.

The server 202 may include a dataset 204 with a plurality of data points 205. For example, the dataset 204 may be for a business entity (e.g., a telecommunication company) and the data points 205 may relate to different attributes (e.g., working hours, commercial plans, and/or contacts at customer service) of that entity.

The processor 201 may generate a plurality of contextual relationships 206 that exist between the data points 205 in the dataset 204, for instance by applying a large language model (LLM) 207 to the dataset 204.

The system may employ a module for database updates, to ensure real-time synchronization and/or updating of the databases. The system may allow accessing the latest data representations for tasks such as similarity matching and/or recommendation systems, maintaining relevance and/or accuracy in responses by dynamically adapting to changes in the underlying data.

In some embodiments, the processor 201 receives a schema of the dataset 204 (e.g., associated with the business entity). The schema may include various remarks, relations, data types, names and/or sample data. This schema may be used by the LLM for?? story assistance that streamlines the creation of narratives and/or dialogues tailored to specific business entities. The schema may facilitate the generation of content for various purposes such as marketing campaigns or user support interactions, to, for example enhance communication effectiveness. Through the use of LLM and/or default prompting, a baseline for a story may be created (e.g., as suggested by the LLM).

An example of default prompting may include standard notices and/or background information such as: our name is “Elite personal helper”, you are a courteous customer service bot agent for “Elite Telco”, a Telecommunication company offering internet, cable and/or phone services to its consumers. The generated bot agent may provide contact information (such as telephone numbers or a website link) through which customers can see their usage, pay bills and/or check equipment status.

According to some embodiments, the agent generation system includes a prompt flow designer as an interface for designing the flow of prompts within the system. The prompt flow designer can allow for the structured arrangement of interactions between users and/or the LLM, ensuring a coherent and/or contextually appropriate dialogue experience. The prompt flow designer may use a visual representation of the conversation states where the control flow is represented by conversation stages and/or dependencies therebetween. The logic to perform at each stage of the conversation may be accordingly represented by LLM actors that use a combination of inputs, conversation states and/or logic, to generate the required output. LLM actors may be configured to receive an input, execute a specific set of actions, and/or generate an output accordingly.

In some embodiments, after the LLM receives initial information, four LLM actors may be automatically created using unique predefined prompts for each actor e.g., as input by an user/admin.

The LLM actors may include at least one of intent, prompt, reflection, knowledge, persona, feedback, and/or fallback. These functional actors may manage distinct aspects of interaction (e.g., with the user). The LLM actors include modules for understanding user intentions, generating prompts, reflecting on past interactions, accessing knowledge bases, adopting personas for varied responses, receiving feedback, and/or handling fallback scenarios to ensure smooth dialogue flow.

A combination of these LLM actors, may allow to model conversation flows that toggle between answering based on conversation context and/or history, LLM model knowledge and/or data retrieval from external sources. In some embodiments, LLM actors may be used to break down user prompts into logical grouping and/or handle aspects of its runtime characteristics such as: synchronous vs asynchronous, effect on chat context, desired output structure, prompt priority, selection of appropriate LLM model.

For example, persona may be an actor with a set of preset prompts that affects the tone of the agent. A preset prompt for the persona actor may be: “Your name is “Elite personal helper”, you are a courteous customer service bot for “Elite Telco”, a Telecommunication company offering internet, cable and/or phone services to its consumers”.

If the prompt is a high priority, its output can become a permanent part of the conversation scope, and/or it can be synchronous in that its output can be used for the conversation to continue.

The fallback actor may be an action to be taken in any case of error and/or inability to find a good response for the prompt. For example, a fallback actor may be an action of automatically prompt the user to provide additional information.

Another example is for a reflection actor that receives the scope of the subject (e.g., the business entity) with a question to the user and/or to the dataset 204, and/or outputs a decision in a standard format that may be used to programmatically continue the flow of the conversation. The output of the reflection actor may be an indication if additional information is required. In some embodiments, the prompt passed and/or the result may not become part of the conversation scope.

Another example is for a knowledge actor that takes a large output such as text or tabular data and, through the use of an LLM model, turns the large output into a set of facts that can become an integral part of the conversation scope. The output may summarize all of the data gathered, and/or dedicated for the agent.

According to some embodiments, structured query language (SQL) to text and/or text to SQL actors may be used for translating between structured SQL database queries and/or natural language text using the LLM. Such translation may enable intuitive communication with database systems, thereby allowing users to interact with databases using human language queries and/or receiving responses in a readable format. The translation may also be used during conversation for data retrieval from the business entity.

Role-based access control (RBAC) and/or attribute based access Control (ABAC) modules may be used for permissions and/or privileges for resource augmented Generation (RAG) and/or data augmented generation (DAG) functionalities. These modules may ensure secure and/or controlled access, safeguarding sensitive the data and/or system resources.

An abstraction layer for the LLM may be used to facilitate the integration of various LLM engines, including both hyper-scaler and/or on-premise models. The abstraction layer offers flexibility and/or scalability in deploying AI solutions, adapting to varying computational resources and/or deployment requirements.

By creating LLM RAG SQL integration, the LLMs capabilities may be combined with the RAG and/or the SQL databases. Such integration may enable advanced language processing within the context of database interactions, facilitating sophisticated query understanding and/or response generation. The solution is based on LLM driven integration, breaking the flow into a number of smaller steps. Each step may be simple enough to be carried out by a LLM with high level of confidence. Thus, the same LLM may be used for various steps in the process in order to achieve the desired result without the need to train the LLM.

In some embodiments, the main steps may be: given a question and/or a schema craft an SQL statement. Run the SQL and/or make sure the SQL returns an appropriate number of rows (e.g., based on the processing limitations of the LLM). Not too many and/or also, depending on the case, not 0.

If the SQL failed or returned an unexpected result, give this feedback to the LLM and/or ask the LLM to generate a new query. Once a good result is accepted, using an LLM, summarize the result in a way that will be useful for the subsequent conversation context.

In some embodiments, the processor 201 determines at least one insight 208 based on the dataset 204 with the generated plurality of contextual relationships 206, by applying the LLM 207 on the dataset 204 with the generated plurality of contextual relationships 206.

Once the at least one insight 208 is determined, the processor 201 may determine at least one query 209 for each corresponding determined at least one insight 208, by applying the LLM 207 on the dataset 204 with the generated plurality of contextual relationships 206 and/or the determined at least one insight 208.

In some embodiments, the processor 201 receives a question 210 for the dataset 204. For example, a user interacts with the processor 201 and/or provides a new question 210. In case that the received question 210 is associated with the determined at least one insight 208, then the processor 201 may apply the LLM 207 on the determined at least one query 209 for the associated determined at least one insight 208.

In some embodiments, in case that the received question 210 is not associated with the determined at least one insight 208, the processor 201 may generate a new query by the LLM 207 for the associated determined at least one insight 208.

The processor 201 may then generate the agent 203 by the LLM 207 based on the determined at least one query 209. Thus, the agent 203 may work with any new question.

In some embodiments, the processor 201 applies the generated agent 203 on at least one received user query 209 and/or the user receives an automatic response.

When interacting with a new user, the agent may start with an introduction message asking how to assist the user. The agent may not assume to know the issue until asked and/or be assertive when the issue is identified. The agent may address the user's issue by at least one of the following: if there are any outstanding invoice payments and/or there is active outages, if there is any other issue that the user is experiencing so may look up data regarding the issue in the database.

In some embodiments, the LLM 207 is updated based on performance of the generated agent 203.

With additional admin prompts the story outline may be further augmented with data that is gathered from the business entity (e.g., with a dedicated database for services queries). In some embodiments, the admin may be a function (either automatic or manual) responsible for pre-setting the system with relevant prompts and/or checking and/or refining the generated test story. Once the story is deemed ready by the admin, the system may be considered ready for general use.

The user may also craft specific queries (e.g., a query as to why the internet connection is offline, issues with billing and/or invoicing) that may then be executed at runtime. The advantage of this process is that once the story is ready (e.g., determined by the admin), the story may be applied to each individual business entity with repeatable and/or consistent results through a combination of the LLM and/or a template module.

The template module may include predefined templates as a starting point for generating prompts, as well as accelerating the development process of user interactions. These templates may cover common scenarios and/or conversation structures, allowing for rapid customization and/or deployment.

Thus, with the user story, there may be less dependency on the LLM at runtime, which is in contrast to more “online” processes that rely on LLM decisions at runtime and/or suffer from unpredictable and/or inconsistent results. The system may allow personalized communication between the user and/or the business entity without compromising private data and/or carried our in near real-time.

The dataset 204 may include a semantic layer of information (or schema) of the dataset. The information at the semantic layer may be received from a dedicated database 220 (e.g., a database dedicated for the semantic layer). In some embodiments, the at least one insight 208 may be determined by a corresponding at least one query 209 to the dedicated database 220 (e.g., instead of the dataset 204).

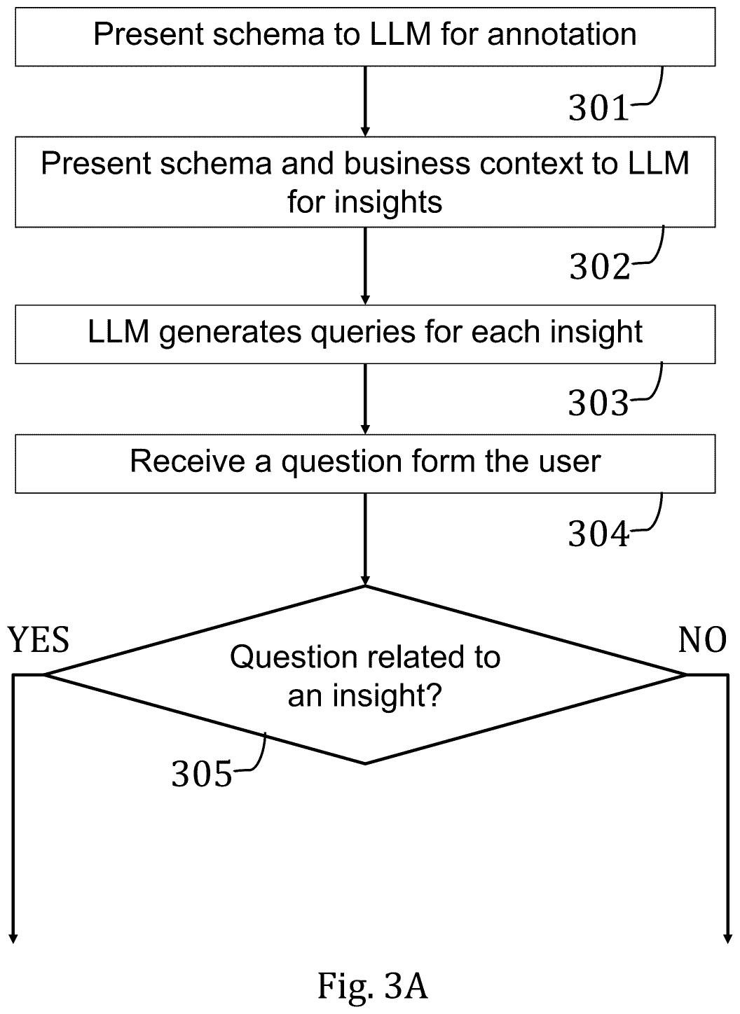

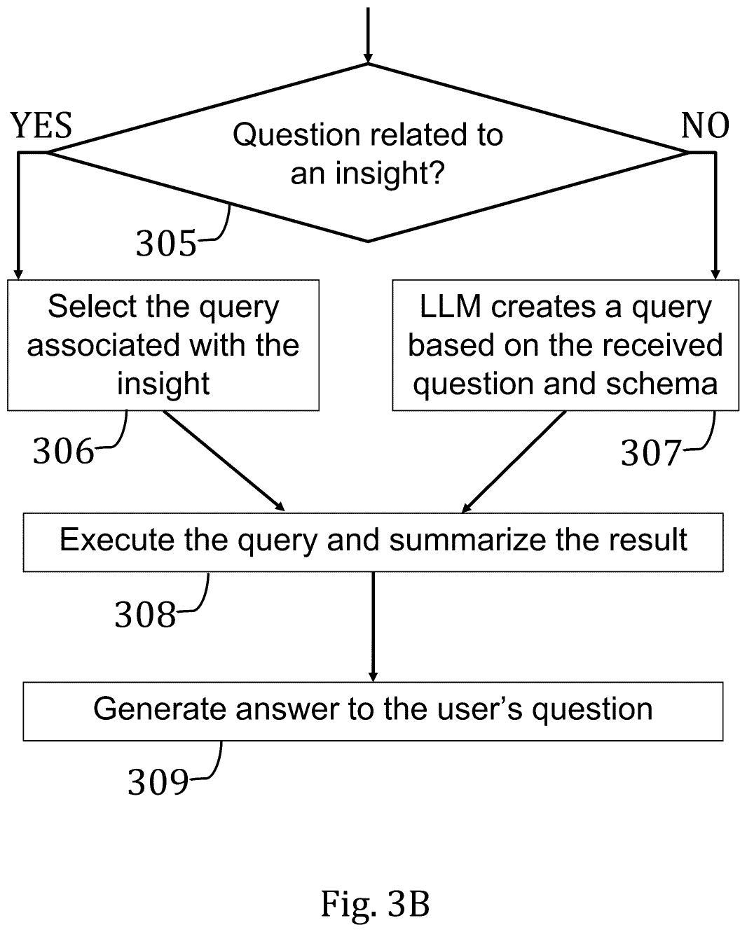

Reference is now made to FIGS. 3A-3B, which show a flowchart for answering a user's query using LLM, according to some embodiments of the invention.

In some embodiments, a single LLM may be used for the entire process so as to reduce processing resources since there's no need for training and/or additional LLM(s).

Initially, a schema (e.g., a schema of a business entity) may be presented 301 to the LLM for annotation.

For example, the system may be initiated, for instance by a predefined admin, by defining the business entity using the existing fabric platform. With an always fresh representation of the business entity the LLM based interaction may be augmented. The representation may be the schema, the relations inside the schema, names, descriptions, or some tagging that were achieved during discovery.

In another example, a schema may include a table with a data sample for an invoice, for example, as shown below in Table 1.

TABLE 1

| Invoice | Table with the invoice information |
|---|---|
| id | The invoice unique identifier |
| date | The date the invoice was issued |
| status | The status of the invoice - ‘paid’, ‘pending’ |
| description | The service description |

A human admin may review the generated annotation and/or refine or modify where desired. For example, the human admin may add a status that was missed or not available in the data sample such as status being “paid”, “pending”, “canceled”, or “uncollectable”.

Once the initial annotations are received, the LLM may be presented 302 with the schema again along with a corresponding context (e.g., to business entity) in order to generate insights from the LLM.

For example, given the above table, and/or the following prompt “Good Gardens is a subscription based gardening company. You are an agent assisting customers in setting up appointments and/or making payments”, the LLM may answer “Check for invoices that are not paid”.

For improved results, a human admin may review the generated insights and/or refine or modify where needed. For example, the human admin may finetune the prompt for the entity as “Check for unpaid invoices and/or uncollectible. Uncollectable invoices indicate a customer that cannot set up new appointments, such a customer needs to call customer service”.

The LLM may then generate 303 at least one query for each insight.

For example, the LLM may answer: “SELECT*FROM Invoice WHERE STATUS in (‘unpaid’, ‘uncollectible’)”.

For improved results, a human admin may review the generated queries and/or modify SQL queries. For example, the human admin may improve the query by optimizing to: “SELECT id, date, status, description FROM Invoice WHERE STATUS in (‘unpaid’, ‘uncollectible’)”.

At this stage, the system may be ready for a new user to receive automatic responses to questions. The LLM may receive 304 a question (e.g., “what are the opening hours?” or “can I setup an appointment for next week? and what is my last paid invoice”) from the user.

In case that the received question is related 305 to the generated insights (e.g., “Yes, need to check that the user doesn't have uncollectable invoices”), the query associated to that insight may be selected 306.

In case that the received question is not related 305 to the generated insights, the LLM may generate 307 a new query based on the received question and/or the received schema.

For example, if the last paid invoice is requested, the LLM may dynamically generate the following: “SELECT id, date, status, description; FROM Invoice; WHERE status=“paid”; ORDER BY date DESC; LIMIT 1;”.

Once the query is selected 306 or generated 307, the system may execute 308 the query and/or summarize the result. For example, the LLM may provide: “The customer has one uncollectible invoice from . . . ”; “The last paid invoice was . . . ”.

Using the summary, a corresponding answer may be generated 307 for the user's question. Thus, with minimal input of the schema, the system may create an agent to address all questions from the user.

For example, the LLM may answer “Thank you for query. Your last paid invoice was. . . . However, given that your invoice from . . . was not paid, you will need to call customer support before I can schedule a new service appointment”.

In some embodiments, when a human user uses the system with a message (or a question), the system may check what operation to carry out by the algorithm. For example, get more data from the database, so may write all the data that is required to assist the client. Accordingly, a query may be created based on the required data to fix the provided query. Once the query is running, if the query fails then another query is created. If the query is successful, the data may be summarized and/or returned to check what operation to do.

In another example, the conversation may be terminated is the issue is resolved, or if assistance is not available so an appropriate response is provided to the client.

In another example, the algorithm may request additional details with a corresponding response requesting information.

The generated agent makes it easier to define during design time the key characteristics of an entity and/or prepare a “recipe” to retrieve the data in easy to consume format (e.g., natural language or aggregate) and/or present the information to the AI engine as available context before the initial interaction is made (examples: key user activities and/or interests, outstanding bills, average usage).

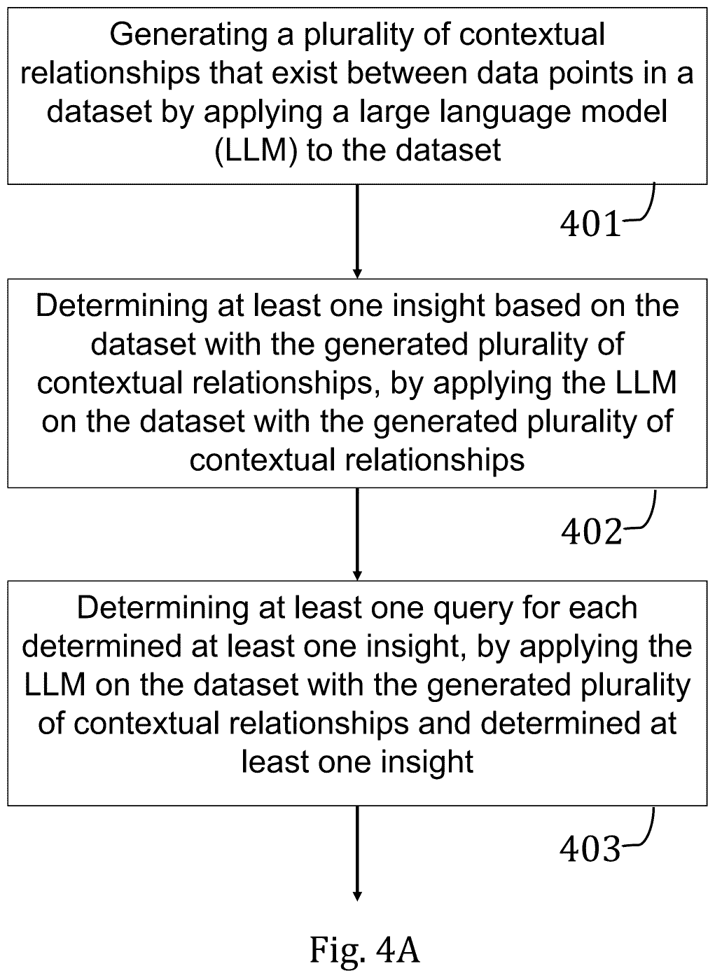

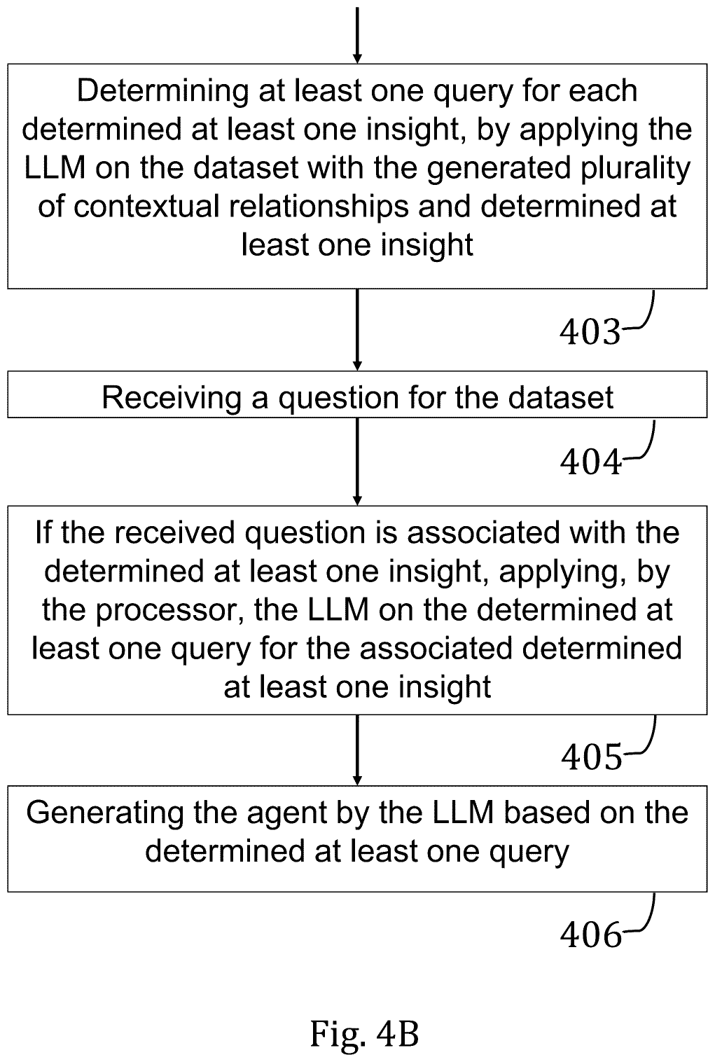

Reference is now made to FIGS. 4A-4B, which show a flowchart for generating an agent, according to some embodiments of the invention.

The processor may generate 401 a plurality of contextual relationships that exist between data points in a dataset by applying a large language model (LLM) to the dataset.

The processor may determine 402 at least one insight based on the dataset with the generated plurality of contextual relationships, by applying the LLM on the dataset with the generated plurality of contextual relationships.

The processor may determine 403 at least one query for each determined at least one insight, by applying the LLM on the dataset with the generated plurality of contextual relationships and/or determined at least one insight. A question may be received 404 for the dataset.

If the received question is associated with the determined at least one insight, the processor may apply 405 the LLM on the determined at least one query for the associated determined at least one insight. Finally, the processor may generate 406 the agent by the LLM based on the determined at least one query.

In some embodiments, the LLM is updated based on performance of the generated agent. The fine-tuning process for the LLM may be designed to adapt the behaviour of the generated agent based on the number and/or nature of user interactions. For example, if the agent includes different “actors” and/or specialized components, the specific actors may be fine-tined to optimize their performance for recurring user patterns. This may include adjusting the weights and/or parameters of the model responsible for a particular aspect of the agent's responses, such as tone, domain-specific knowledge, or interaction style. By leveraging user interaction data, it may be possible to identify areas where the agent may improve and/or focus the fine-tuning process on those areas.

For example, if a user frequently interacts with the agent regarding financial planning, the actor responsible for financial responses may be fine-tuned to improve the relevance, accuracy, and/or detail of the generated output. This adaptation may ensure that the agent becomes more personalized and context-aware over time, enhancing user satisfaction and engagement.

While certain features of the invention have been illustrated and/or described herein, many modifications, substitutions, changes, and/or equivalents may occur to those skilled in the art. It is, therefore, to be understood that the appended claims are intended to cover all such modifications and/or changes.

Various embodiments have been presented. Each of these embodiments may of course include features from other embodiments presented, and embodiments not specifically described may include various features described herein.

1. A method of generating an agent, the method comprising:
generating, by a processor, a plurality of contextual relationships that exist between data points in a dataset by applying a large language model (LLM) to the dataset;
determining, by the processor, at least one insight based on the dataset with the generated plurality of contextual relationships, by applying the LLM on the dataset with the generated plurality of contextual relationships;
determining, by the processor, at least one query for each determined at least one insight, by applying the LLM on the dataset with the generated plurality of contextual relationships and determined at least one insight;
receiving, by the processor, a question for the dataset;
if the received question is associated with the determined at least one insight, applying, by the processor, the LLM on the determined at least one query for the associated determined at least one insight;
generating, by the processor, the agent by the LLM based on the determined at least one query; and
updating the LLM based on performance of the generated agent.

2. The method of claim 1, further comprising if the received question is not associated with the determined at least one insight, generating, by the processor, a new query by the LLM for the associated determined at least one insight.

3. The method of claim 1, further comprising applying, by the processor, the generated agent on at least one received user query.

4. The method of claim 1, wherein the dataset comprises a semantic layer of information of the dataset.

5. The method of claim 4, wherein the information is received from a dedicated database.

6. The method of claim 5, wherein the at least one insight is determined by a corresponding at least one query to the dedicated database.

7. A system for generating an agent, the system comprising:
a server, comprising a dataset with a plurality of data points; and
a processor, in communication with the server, wherein the processor is configured to:
generate a plurality of contextual relationships that exist between data points in the dataset by applying a large language model (LLM) to the dataset;
determine at least one insight based on the dataset with the generated plurality of contextual relationships, by applying the LLM on the dataset with the generated plurality of contextual relationships;
determine at least one query for each determined at least one insight, by applying the LLM on the dataset with the generated plurality of contextual relationships and determined at least one insight;
receive a question for the dataset;
if the received question is associated with the determined at least one insight, apply the LLM on the determined at least one query for the associated determined at least one insight;
generate the agent by the LLM based on the determined at least one query; and
update the LLM based on performance of the generated agent.

8. The system of claim 7, wherein the processor is further configured to generate a new query by the LLM for the associated determined at least one insight, if the received question is not associated with the determined at least one insight.

9. The system of claim 7, wherein the processor is further configured to apply the generated agent on at least one received user query.

10. The system of claim 7, wherein the dataset comprises a semantic layer of information of the dataset.

11. The system of claim 10, wherein the information is received from a dedicated database.

12. The system of claim 11, wherein the at least one insight is determined by a corresponding at least one query to the dedicated database.

13. A computer-readable medium comprising instructions which, when executed by a processor, cause the processor to:
generate a plurality of contextual relationships that exist between data points in a dataset by applying a large language model (LLM) to the dataset;
determine at least one insight based on the dataset with the generated plurality of contextual relationships, by applying the LLM on the dataset with the generated plurality of contextual relationships;
determine at least one query for each determined at least one insight, by applying the LLM on the dataset with the generated plurality of contextual relationships and determined at least one insight;
receive a question for the dataset;
if the received question is associated with the determined at least one insight, apply the LLM on the determined at least one query for the associated determined at least one insight;
generate the agent by the LLM based on the determined at least one query; and
update the LLM based on performance of the generated agent.

14. The system of claim 13, wherein the processor is further configured to generate a new query by the LLM for the associated determined at least one insight, if the received question is not associated with the determined at least one insight.

15. The system of claim 13, wherein the processor is further configured to apply the generated agent on at least one received user query.

16. The system of claim 13, wherein the dataset comprises a semantic layer of information of the dataset.

17. The system of claim 16, wherein the information is received from a dedicated database.

18. The system of claim 17, wherein the at least one insight is determined by a corresponding at least one query to the dedicated database.
